(19) United States
(12) Patent Application Publication
(10) Pub. No.: US 2020/0263900 A1
(43) Pub. Date: Aug. 20, 2020

(54) WATER RESISTANT VENT FOR AN UNMANNED AERIAL VEHICLE

(71) Applicant: Hoverfly Technologies, Inc., Orlando, FL (US)

(72) Inventor: Lucas Colt Whitaker, San Leandro, CA (US)

(21) Appl. No.: 16/789,927

(22) Filed: Feb. 13, 2020

Related U.S. Application Data
(60) Provisional application No. 62/806,447, filed on Feb. 15, 2019.

(51) Int. Cl. F24F 13/08; B64C 39/02

(52) U.S. Cl. CPC F24F 13/08; B64C 2201/108; B64C 2201/027; B64C 39/024

(57) ABSTRACT

An unmanned aerial vehicle includes a platform. An altimeter is mounted in an interior of the platform. The platform is formed with an opening therein providing access to the interior of the platform from an exterior of the platform. A vent is disposed within the opening of the platform and forms a channel configured to allow air to move from the exterior of the platform to the interior of the platform along the entire length of the channel, and preventing ambient water from travelling from the exterior of the platform through an entire length of the channel.

### CROSS REFERENCE TO RELATED APPLICATION

This application claims prior to U.S. Provisional Application No. 62/806,447 filed Feb. 15, 2019, the contents of which are herein incorporated.

### BACKGROUND OF THE INVENTION

The present invention relates to an Unmanned Aerial Vehicle (“UAV”), and more particularly a structure for protecting circuitry mounted on the UAV platform from the elements while providing exposure to the environment in which the UAV is traveling.

There are many uses for measuring ambient pressure at altitude and many reasons to do so. One such application is the measure of ambient air pressure to determine the altitude of a device or system, such as a UAV. It is well known in the art to determine altitude from air pressure by knowing the weight of a column of air above the device in question. The higher the sensing device the lower the weight and therefore decreased pressure. A simple calculation is used to provide the altitude based on the measured ambient pressure.

Altitude detection assumes some exposure to the ambient atmosphere to “weigh” the air column. This is true even when pressure-based altimeters, which are routinely used in aircraft, are used to monitor vertical locations above ground. It is known for UAVs to utilize miniature pressure sensors to determine altitude. Since reduced weight, size, and energy consumption are a significant factor in the design of UAVs, these miniature pressure sensors are often incorporated directly with other electronics into a single printed circuit board assembly. However, to sense air pressure the sensor must be mounted in a way to be exposed to the elements. These elements include rain which may damage the circuit board. Furthermore, in the UAV environment, the UAV platform experiences turbulence from wind, or the rotors themselves, driving the rain towards the UAV platform to which the sensor is mounted; further exposing the sensitive electronics to damaging water.

As a result of such design constraints, it is difficult, and potentially impossible, to design the system with resistance to water and other environmental concerns, while at the same time providing exposure to air pressure. Some have proposed a water resistant system requiring an enclosed box sealed from the ambient environment with an internal pressure that can change instantaneously with ambient pressure. However this adds undue complexity, structure and associated increase in payload to the UAV design.

Accordingly, there is a need for a UAV platform utilizing a pressure-based altimeter which overcomes the shortcomings of the prior art.

### SUMMARY OF THE INVENTION

An unmanned aerial vehicle includes a platform. An altimeter is mounted in an interior of the platform. The platform is formed with an opening therein providing access to the interior of the platform from an exterior of the platform. A vent is disposed within the opening of the platform and forms a channel configured to allow air to move from the exterior of the platform to the interior of the platform along the entire length of the channel, and preventing ambient water from travelling from the exterior of the platform through an entire length of the channel.

### BRIEF DESCRIPTION OF THE DRAWINGS

The features and advantages of the present invention will become more readily apparent from the following detailed description of the invention in which like elements are labeled similarly and in which:

FIG. 1 is a schematic diagram of a an unmanned aerial vehicle constructed in accordance with the invention;

FIG. 2 is a perspective view of a vent constructed in accordance with the invention;

FIG. 3 is a sectional view taken along line 3-3 of FIG. 2 ; and

FIG. 4 is a rotated plan view of the sectional view of FIG. 3.

### DETAILED DESCRIPTION OF THE PREFERRED EMBODIMENTS

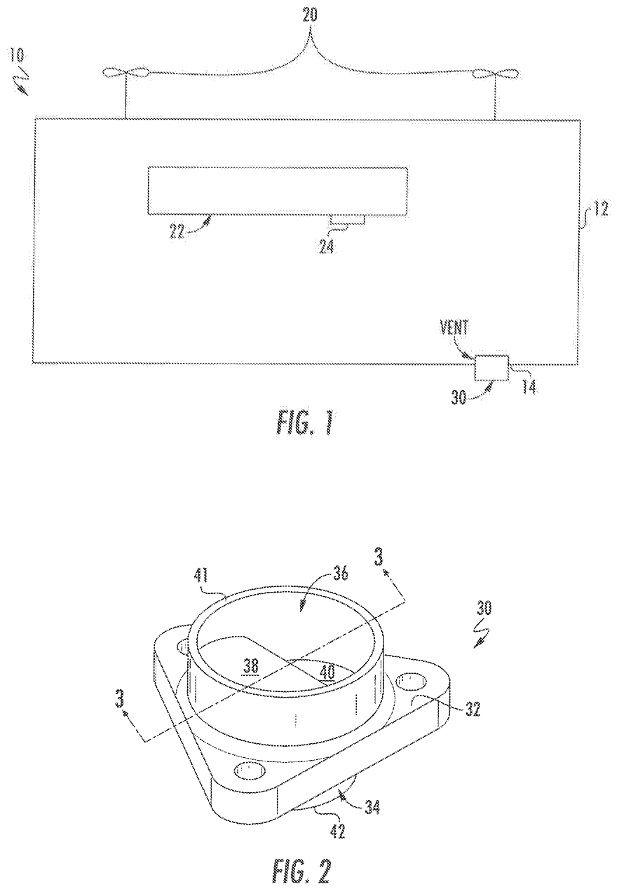

Reference is initially made to FIG. 1 in which a UAV, generally indicated as 10, constructed in accordance with the invention is provided. UAV 10 includes a platform 12 in the form of an enclosure. Platform 12 is formed with an opening 14 therein which provides access to the interior of platform 12 from the exterior of platform 12. As known in the art, rotors 20 extend from platform 12. Electronics 22, including a pressure sensor type altimeter 24 are mounted within housing 12. A vent 30 for enabling air flow through opening 14, but not rain or other liquids is disposed within opening 14.

Platform 12 has a top, facing away from the ground, during operation, and a bottom is primarily facing towards ground during operation. In a nonlimiting embodiment opening 14 is formed in the of platform 12.

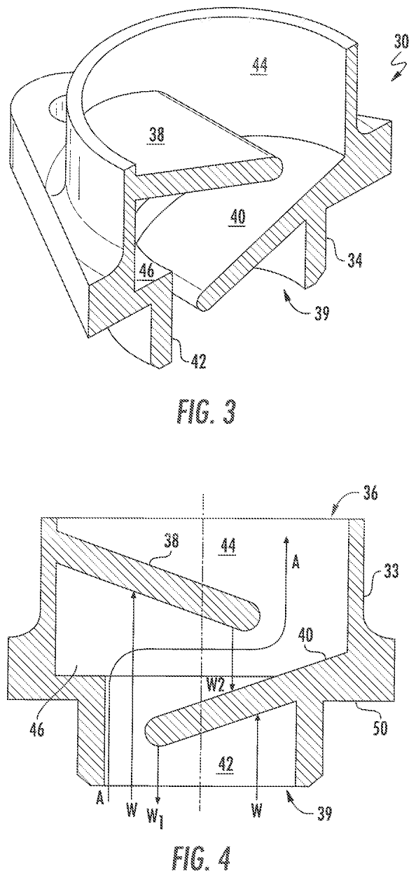

Reference is now made to FIGS. 2-4 in which the structure of vent 30 is shown with greater particularity. Vent 30 is formed as a tube 34 having a first portion 44 and a second portion 42 contiguous therewith. A first louver 38 extends from an interior sidewall of first portion 44 across a centerline C-C of tube 34. A second louver 40 extends from an interior sidewall of second portion 42 across center line C-C of tube 34. As a result, louver 38 overlaps louver 40 a predetermined amount in a direction along the length of tube 34, while maintaining a non straight line passageway A through the length of a channel formed by vent 30.

In a preferred nonlimiting embodiment, each of louvers 38, 40 are angled in a direction of entrance 39. Furthermore, in a preferred nonlimiting embodiment, the inner diameter of second portion 42 is less than the inner diameter of first portion 44. This results in a step 46 formed within the channel of tube 30. Additionally, in a nonlimiting embodiment, the cross sectional area of tube entrance 39, formed by second portion 42, is less than the cross sectional area of an exit 36 of tube 34 limiting access to vent 30 while promoting exit therefrom once traversed.

Additionally, vent 30 may be maintained within opening 14 by way of tension fit, or adhesive between an outer surface of tube 34 and the interior surface of opening 14. However in a preferred, nonlimiting embodiment, a support 32 extends from an outer diameter of tube 34 and has a diameter greater than the inner diameter of opening 14 to engage the portion of platform 12 adjacent opening 14 located at an exterior under side of platform 12.. Additionally, an outer diameter of first portion 44 is greater than an outer diameter of second portion 42 forming a stepped deck 50 form platform 12 and maintain vent 30 in place. It is well within the scope of the invention for first portion 44 and second portion 42 to have substantially identical interior diameters and/or exterior diameters.

While tube 34 has been shown as cylindrical in shape, tube 34 may be any shape such as square, hexagonal, round or the like. Furthermore, while at least two louvers are shown stacked inside of tube 34, any number of overlaying louvers may be used so long as they do not prevent the free flow of air through tube 34 as discussed below. In addition, an open cell foam or screen can be used (not shown) disposed within tube 34 to reduce particle ingress.

During operation, water entering entrance 39 in the directions of arrows W will engage louver 40 and either bounce off of louver 40 falling from entrance 39, or as a result of the downward angle of louver 40, water will adhere to an underside of louver 42, wick along louver 42 then fall from louver 40 in the direction of arrow W₁. Any water reaching louver 38 will either be deflected back towards entrance 39 or, as a result of the angled structure of louver 38, will wick along louver 38 and as the result of the weight of water, and angle of louver 38, will fall in the direction of arrow W₂ upon louver 40 where it will then travel louver 40 under the influence of gravity and fall from entrance 39.

At the same time, air entering entrance 39 of tube 34 may be deflected by louver 38, but will not fall, and will continue through the entire length of the channel formed by the interior of tube 34; along pathway A-A forming the channel. In this way, air leaves exit 36 into the interior of platform 12 to be sensed by pressure sensor 24.

It should be further recognized that the invention is not limited to the particular embodiments described above. Accordingly, numerous modifications can be made without departing from the spirit of the invention and scope of the claims appended hereto.

What is claimed is:

1. An unmanned aerial vehicle comprising;
a platform, the platform formed with an opening therein providing access to an interior of the platform from an exterior of the platform;
an altimeter mounted in the interior of the platform; and
a vent mounted within the opening of the platform providing a channel configured to allow air to move from the exterior of the platform to the interior of the platform and preventing ambient water from traveling through an entire length of the channel.

2. The unmanned aerial vehicle of claim 1, wherein the opening is formed in a bottom of the unmanned aerial vehicle.

3. The unmanned aerial vehicle of claim 1, wherein the vent comprises a tube disposed in the opening.

4. The unmanned aerial vehicle of claim 3, wherein the vent further comprises at least a first louver extending within the tube; and at least a second louver extending within the tube; the first louver and second louver defining the channel.

5. The unmanned aerial vehicle of claim 4, wherein at least one of the first louver and second louver is angled away from a top of the platform.

6. The unmanned aerial vehicle of claim 4, wherein the tube has an interior centerline, the first louver extends from an interior sidewall of the tube across the central line, and the second louver extends from an interior sidewall of the tube across the centerline.

7. The unmanned aerial vehicle of claim 2, wherein the tube includes a first portion and a second portion, the first portion extending into an interior of the platform and the second portion extending from the exterior of the platform, and a cross sectional area of the second portion being less than a cross sectional area of the first portion.
